(19) United States
(12) Patent Application Publication
(10) Pub. No.: US 2016/0075845 A1
(43) Pub. Date: Mar. 17, 2016

(54) Membrane formulation of fluorinated copolymer porous membrance and preparing method thereof

(71) Applicant: TIANJIN POLYTECHNIC UNIVERSITY, Tianjin (CN)

(72) Inventors: Changfa Xiao, Tianjin (CN); Jian Pan, Tianjin (CN); Qinglin Huang, Tianjin (CN); Hailiang Liu, Tianjin (CN); Zhen Liu, Tianjin (CN); Guolan Huan, Tianjin (CN)

(73) Assignee: TIANJIN POLYTECHNIC UNIVERSITY

(21) Appl. No.: 14/949,889

(22) Filed: Nov. 24, 2015

(30) Foreign Application Priority Data
Jan. 12, 2015 (CN) 201510013245.2

(51) Int. Cl. C08J 9/12; B29C 43/02; B29C 43/52; C08J 9/00

(52) U.S. Cl. CPC C08J 9/12; C08J 9/0023; B29C 43/02; B29C 43/52; C08J 2323/08; C08J 2327/12; B29K 2023/08

(57) ABSTRACT

A membrane formulation of fluorinated copolymer porous membrane includes: 15-50 wt % ethylene-chlorotrifluoroethylene copolymer, 30-85 wt % diluent and 0-20 wt % composite pore-forming agent, totally 100 wt %; wherein the diluent is selected from a group consisting of di-isooctyladinpate, di-isooctyladinpate with dibutyl phthalate, diethyl phthalate and dioctyl phthalate with any proportion. Methods for preparing a fluorinated copolymer porous flat membrane and a fluorinated copolymer hollow fiber porous membrane with the above formulation are also provided. With the formulation, a membrane-forming temperature is reduced to below 200° C., and processes thereof are convenient. Furthermore, membrane mechanical property is excellent, porosity is high, permeability is sufficient, and the method is suitable for membrane separation under severe conditions such as acid-base mediums and organic solvents.

### CROSS REFERENCE OF RELATED APPLICATION

The present invention claims priority under 35 U.S.C. 119(a-d) to CN 201510013245.2, filed Jan. 12, 2015.

### BACKGROUND OF THE PRESENT INVENTION

1. Field of Invention

The present invention relates to a technical field of membrane, and more particularly to a membrane formulation of fluorinated copolymer porous membrane and a preparing method thereof.

2. Description of Related Arts

Poly(ethylene chlorotrifluoroethylene), ECTFE for short, is a semi-crystalline, thermoplastic polymer with good mechanical properties, excellent heat resistance, chemical resistance and weathering resistance; wherein chemical corrosion resistance thereof equals to the one of PTFE, and better than that of polyvinylidene fluoride. Conventional solvents are not able to dissolve ECTFE with a temperature below 120° C. Because of excellent corrosion resistance, outstanding impact resistance and tough mechanical strength, the ECTFE is widely used in preparation of wires, cables, filter shell, etc. The ECTFE is applicable to special environments such as high temperature and high corrosion. Therefore, the ECTFE has broad application prospects in a separation field, which is an ideal membrane material. Because there is no proper solvent at room temperature, thermal induced phase separation (TIPS) is considered to be the most suitable method for preparing ECTFE microporous membranes.

Referring to U.S. Pat. Nos. 4,623,670 and 4,702,836, ECTFE is dissolved in chlorotrifluoroethylene at a high temperature, and silica is added. After being melted and extruded, the ECTFE is quenched into a membrane. The chlorotrifluoroethylene is extracted by methyl chloroform, and silicon dioxide is removed by hot sodium hydroxide, for obtaining an ECTFE porous membrane. During the above process, as the diluent, chlorotrifluoroethylene is expensive; as the extractant, methyl chloroform is high in toxicity; the process is complicated; and the membrane pore size is not easy to be controlled. Referring to U.S. Pat. No. 7,247,238, citric acid ethyl ester or glycerol triacetate is chosen as the diluent, and silica is mixed, in such a manner that the ECTFE porous membrane is prepared by the TIPS method, wherein hot alkali solution is needed for dissolving silica, but the operation is complex, and membrane pore structure is not easy to be controlled. Ramaswamy et al. and ZHOU et al. respectively uses dibutyl phthalate (DBP) and diethyl phthalate (DEP) as diluent, wherein membranes with different pore structures are obtained by adjusting a quenching temperature. However, membrane surface layers are thick, perforated rate is low. With the above membrane preparation methods, a temperature must be kept above 250° C. for keeping homogeneity, while ECTFE mechanical property requires a max temperature of 175° C., preferably 150° C. The ECTFE will be partly decomposed after being exposed to a high temperature for a long time. Fluoride of decomposed product will corrode equipments, which reduces production efficiency and increases cost.

### SUMMARY OF THE PRESENT INVENTION

A first object of the present invention is to provide a fluorinated copolymer porous membrane formulation; by the formulation, during preparation of ethylene-chlorotrifluoroethylene copolymer flat membrane or hollow fiber membrane, a membrane-forming temperature is reduced to below 200° C., and processes thereof are easy.

A second object of the present invention is to provide a preparation method of the fluorinated copolymer flat porous membrane with the above formulation.

A third object of the present invention is to provide a preparation method of the fluorinated copolymer hollow fiber porous membrane with the above formulation.

Advantages of the fluorinated copolymer flat porous membrane or the fluorinated copolymer hollow fiber porous membrane prepared have excellent mechanical property, high porosity, sufficient permeability, etc.; which is suitable for membrane separation systems under severe conditions such as acid-base mediums and organic solvents.

Accordingly, in order to accomplish the above objects, the present invention provides:

a membrane formulation of fluorinated copolymer porous membrane, comprising:
a fluorinated copolymer 15-50 wt %;
a diluent 30-85 wt %; and
a composite pore-forming agent 0-20 wt %; totally 100 wt %;

wherein the fluorinated copolymer is ethylene-chlorotrifluoroethylene; preferably, the fluorinated copolymer is the ethylene-chlorotrifluoroethylene formed by alternating copolymerization of ethylene and chlorotrifluoroethylene monomer with a proportion of 1:1;

wherein the diluent is selected from a group consisting of di-isooctyladinpate, di-isooctyladinpate with dibutyl phthalate, diethyl phthalate and dioctyl phthalate, with any proportion;

wherein the composite pore-forming agent is a dissoluble pore-forming agent or a non-dissoluble pore-forming agent, wherein the dissoluble pore-forming agent is water-soluble inorganic particles, a water-soluble polymer, or a mixture of the water-soluble inorganic particles and the water-soluble polymer with any proportion;

wherein the water-soluble inorganic particles are selected from a group consisting of LiCl, CaCl₂, NaCl and KCl with an average particle size of 0.01-5 μm; the water-soluble polymer has a decomposing temperature higher than a processing temperature of the ethylene-chlorotrifluoroethylene copolymer; preferably, the water-soluble polymer is polyoxyethylene or polyethyleneglycol;

wherein the non-dissoluble pore-forming agent is non-water-soluble inorganic particles; preferably, the non-water-soluble inorganic particles have an average particle size of 0.01-5 μm, and are SiO₂, CaCO₃, or SiO₂ and CaCO₃ with any proportion.

According to the present invention, the more the fluorinated copolymer is, the better the mechanism property of the porous membrane will be, but the porosity will be lowered. For obtaining a porous membrane with sufficient overall performances comprising mechanism property, porosity and rejection rate, the content of the fluorinated copolymer is controlled at 15-50 wt %.

According to the present invention, the diluent is an organic reagent with a high boiling point and a low molecular weight, wherein the diluent is able to form the homogeneous phase solution with the fluorinated copolymer at a temperature of below 200° C. Because two phase components of the fluorinated copolymer and the diluent are able to prepare the porous membrane, the content of the diluent may be controlled within a high range of 30-85 wt %.

According to the present invention, the decomposing temperature of the composite pore-forming agent is required to be higher than the processing temperature of a membrane-forming temperature. During membrane forming, porosity and water flux of the porous membrane will be increased with increasing of the composite pore-forming agent, but mechanical property will be lowered. For balancing a total performance of the porous membrane, an amount of the composite pore-forming agent is 0-20 wt % of a membrane-forming system.

A method for preparing a fluorinated copolymer flat porous membrane with the above formulation comprises steps of:

1) evenly mixing a fluorinated copolymer, a diluent and a composite pore-forming agent with a certain proportion, for forming a viscous mixture;

2) pre-heating a mould of a hot-presser with a temperature of 170-200° C., pouring the viscous mixture into the mould after a mould temperature is balanced, pressing with a pressure of 10-30 MPa after the viscous mixture is completely melted and forms a homogeneous phase, so as to form a first flat membrane; and

3) cooling the mould with cool water, taking the first flat membrane out after being cooled and solidified, extracting with alcohol for obtaining a first fluorinated copolymer flat porous membrane.

Another method for preparing the fluorinated copolymer flat porous membrane with the above formulation comprises steps of:

1) evenly mixing a fluorinated copolymer, a diluent and a composite pore-forming agent with a certain proportion, for forming a viscous mixture; thoroughly stirring the viscous mixture at 180-200° C., for forming a homogeneous phase solution, then keeping a temperature at 180-200° C. and waiting for deforming, so as to obtain a homogeneous casting solution;

2) rapidly coating the casting solution on a clean glass board which is thoroughly pre-heated at 170-200° C., for obtaining a second flat membrane; and

3) putting the second flat membrane at a 20-80° C. water bath, taking out after being cooled and solidified, extracting with alcohol for obtaining a second fluorinated copolymer flat porous membrane.

A method for preparing a fluorinated copolymer hollow fiber porous membrane with the above formulation comprises steps of:

1) evenly mixing a fluorinated copolymer, a diluent and a composite pore-forming agent with a certain proportion, for forming a viscous mixture;

2) inputting the viscous mixture into a screw extruder, extruding out through a hollow spinning nozzle at 170-200° C., passing through a 20-150 mm air layer, then immersing into a 20-80° C. water bath for being solidified, so as to obtaining a first primary hollow fiber; and

3) extracting the first primary hollow fiber with alcohol for obtaining a first fluorinated copolymer hollow fiber porous membrane.

Another method for preparing a fluorinated copolymer hollow fiber porous membrane with the above formulation comprises steps of:

1) mixing a fluorinated copolymer, a diluent and a composite pore-forming agent with a certain proportion, for forming a viscous mixture; thoroughly stirring the viscous mixture at 180-200° C., for forming a homogeneous phase solution, then keeping a temperature at 180-200° C. and waiting for deforming, so as to obtain a homogeneous casting solution;

2) inputting the casting solution into a screw extruder, extruding out through a hollow spinning nozzle at 170-200° C., passing through a 20-150 mm air layer, then immersing into a 20-80° C. water bath for being solidified, so as to obtaining a second primary hollow fiber; and

3) extracting the second primary hollow fiber with alcohol for obtaining a second fluorinated copolymer hollow fiber porous membrane.

According to the present invention, a temperature range for preparing the casting solution is 180-200° C., wherein a temperature of a specific method depends on the diluent selected, the proportion of the diluent, and the amount of the composite pore-forming agent.

According to the present invention, a temperature range for membrane forming is 170-200° C., wherein besides the diluent selected, the proportion of the diluent, and the amount of the composite pore-forming agent, a temperature of a specific method also depends on the fluorinated copolymer selected, because an amount of the polymer determines a total viscosity of the membrane-forming system.

Compared with the conventional technologies, the method for preparing the fluorinated copolymer porous membrane according to the present invention is suitable for preparing ECTFE porous membranes with a thermally induced phase separation method, which is able to effectively decrease an ECTFE membrane forming temperature. Conventionally reported ECTFE membrane forming temperature of thermally induced phase separation is generally about 250° C. However, according to the present invention, the porous membrane forming temperature is only 180-200° C., which saves power. The diluent thereof is low-toxicity and low-pollution agent, which is eco-friendly. The membrane forming process is relatively simply and short, which has a high efficiency and is suitable for industrialization.

These and other objectives, features, and advantages of the present invention will become apparent from the following detailed description and the appended claims.

### DETAILED DESCRIPTION OF THE PREFERRED EMBODIMENT

Referring to preferred embodiments, the present invention is further illustrated in detail.

### Preferred Embodiment 1

Referring to table 1, preparation formulations of 6 fluorinated copolymer porous membranes are provided.

TABLE 1

| | ethylene-chlorotrifluoroethylene | |
|---|---|---|
| | copolymer | diluent: di-isooctyladinpate |
| 1# | 20 wt % | 80 wt % |
| 2# | 30 wt % | 70 wt % |
| 3# | 40 wt % | 60 wt % |
| 4# | 50 wt % | 50 wt % |
| 5# | 12 wt % | 85 wt % |
| 6# | 20 wt % | 80 wt % |

Note:
the ethylene-chlorotrifluoroethylene copolymer is Halar ® 902 from Solvay (Shanghai) Company, Ltd.

Respectively, 1-4# proportions are used for preparing a first fluorinated copolymer flat porous membrane according to following steps:

1) evenly mixing the fluorinated copolymer and the di-isooctyladinpate with the proportion, for forming a viscous mixture;

2) pre-heating a mould of a hot-presser with a temperature of 180° C., wherein the mould is a groove with a thickness of 200 μm formed by opposite faces of a pair of stainless steel plates; pouring the viscous mixture into the mould after a mould temperature is balanced, pressing with a pressure of 15 MPa after the viscous mixture is completely melted and forms a homogeneous phase, so as to form a first flat membrane; and

3) cooling the mould with cool water, taking the first flat membrane out after being cooled and solidified, extracting with alcohol for obtaining a first fluorinated copolymer flat porous membrane.

The first fluorinated copolymer flat porous membranes prepared with the 1-4# proportions are correspondingly marked as 1-4#.

Respectively, 5-6# proportions are used for preparing a second fluorinated copolymer flat porous membrane according to following steps:

1) evenly mixing the fluorinated copolymer and the di-isooctyladinpate with the proportion, for forming a viscous mixture; thoroughly stirring the viscous mixture at 180° C., for forming a homogeneous phase solution, then keeping a temperature at 180° C. and waiting for deforming, so as to obtain a homogeneous casting solution;

2) rapidly coating the casting solution on a clean glass board which is thoroughly pre-heated at 180° C., for obtaining a second flat membrane; and

3) putting the second flat membrane at a 20° C. water bath, taking out after being cooled and solidified, extracting with alcohol for obtaining a second fluorinated copolymer flat porous membrane.

The second fluorinated copolymer flat porous membranes prepared with the 5-6# proportions are correspondingly marked as 5-6#.

### Preferred Embodiment 2

Referring to table 2, preparation formulations of 2 fluorinated copolymer porous membranes are provided.

TABLE 2

| | ethylene- | | |
|---|---|---|---|
| | chlorotrifluoroethylene | diluent: di- | diluent: diethyl |
| | copolymer/wt % | isooctyladinpate/wt % | phthalate/wt % |
| 7# | 25 | 37.5 | 37.5 |
| 8# | 25 | 19 | 56 |

Note:
the ethylene-chlorotrifluoroethylene copolymer is Halar ® 902 from Solvay (Shanghai) Company, Ltd.

Respectively, 7-8# proportions are used for preparing a first fluorinated copolymer flat porous membrane according to following steps:

1) evenly mixing the fluorinated copolymer, the di-isooctyladinpate and the diethyl phthalate with the proportion, for forming a viscous mixture;

2) pre-heating a mould of a hot-presser with a temperature of 180° C., wherein the mould is a groove with a thickness of 200 μm formed by opposite faces of a pair of stainless steel plates; pouring the viscous mixture into the mould after a mould temperature is balanced, pressing with a pressure of 15 MPa after the viscous mixture is completely melted and forms a homogeneous phase, so as to form a first flat membrane; and

3) cooling the mould with cool water, taking the first flat membrane out after being cooled and solidified, extracting with alcohol for obtaining a first fluorinated copolymer flat porous membrane.

The first fluorinated copolymer flat porous membranes prepared with the 7-8# proportions are correspondingly marked as 7-8#.

### Preferred Embodiment 3

Referring to table 3, preparation formulations of 2 fluorinated copolymer porous membranes are provided.

TABLE 3

| | | | composite |
|---|---|---|---|
| | | | pore-forming |
| | | | agent: SiO₂ with |
| | ethylene- | | particle |
| | chlorotrifluoroethylene | diluent: di- | size of |
| | copolymer/wt % | isooctyladinpate/wt % | 1-5 μm/wt % |
| 9# | 20 | 77 | 3 |
| 10# | 30 | 65.5 | 4.5 |

Note:
the ethylene-chlorotrifluoroethylene copolymer is Halar ® 902 from Solvay (Shanghai) Company, Ltd.

Respectively, 9-10# proportions are used for preparing a first fluorinated copolymer flat porous membrane according to following steps:

1) evenly mixing the fluorinated copolymer, the di-isooctyladinpate and the SiO₂ with the proportion, for forming a viscous mixture;

2) pre-heating a mould of a hot-presser with a temperature of 180° C., wherein the mould is a groove with a thickness of 200 μm formed by opposite faces of a pair of stainless steel plates; pouring the viscous mixture into the mould after a mould temperature is balanced, pressing with a pressure of 15 MPa after the viscous mixture is completely melted and forms a homogeneous phase, so as to form a first flat membrane; and

3) cooling the mould with cool water, taking the first flat membrane out after being cooled and solidified, extracting with alcohol for obtaining a first fluorinated copolymer flat porous membrane.

The first fluorinated copolymer flat porous membranes prepared with the 9-10# proportions are correspondingly marked as 9-10#.

### Preferred Embodiment 4

A method for preparing a fluorinated copolymer hollow fiber porous membrane comprises steps of:

1) evenly mixing 46.7 wt % ethylene-chlorotrifluoroethylene copolymer, 46.7 wt % di-isooctyladinpate and 6.6 wt % SiO₂ with a particle size of 1-5 μm, for forming a viscous mixture;

2) inputting the viscous mixture into a screw extruder, extruding out through a three-area double-screw extruder, wherein temperatures of three areas are respectively 200° C., 195° C. and 190° C., and a temperature of a spinning nozzle is 200° C.; passing through a 120 mm air layer, then immersing into a 20° C. water bath for being solidified, so as to obtain a first primary hollow fiber; and

3) extracting the first primary hollow fiber with alcohol for obtaining a fluorinated copolymer hollow fiber porous membrane, which is marked as 11#.

### Preferred Embodiment 5

A method for preparing a fluorinated copolymer hollow fiber porous membrane comprises steps of:

1) evenly mixing 35 wt % ethylene-chlorotrifluoroethylene copolymer, 60 wt % di-isooctyladinpate, 3 wt % SiO₂ with a particle size of 1-5 μm, and 2 wt % PEG2000, for forming a viscous mixture; thoroughly stirring the viscous mixture at 190° C., for forming a homogeneous phase solution, then keeping a temperature at 190° C. and waiting for deforming, so as to obtain a homogeneous casting solution;

2) inputting the viscous mixture into a single-screw extruder, wherein temperatures of three areas of the single-screw extruder are respectively 190° C., 185° C. and 180° C., and a temperature of a spinning nozzle is 195° C.; passing through a 100 mm air layer, then immersing into a 20° C. water bath for being solidified, so as to obtaining a second primary hollow fiber; and

3) extracting the second primary hollow fiber with alcohol for obtaining a second fluorinated copolymer hollow fiber porous membrane, which is marked as 12#.

According to the present invention, porosity and breaking strength tests are provided to the fluorinated copolymer flat porous membranes and the fluorinated copolymer hollow fiber porous membranes obtained in the above preferred embodiments.

Results are listed in table 4. A weighting method is used for the porosity test, which is calculated according to a formula (1).

$$ɛ ( \% ) = \frac{( {m}_{1} - {m}_{2} ) / {ρ}_{L}}{( {m}_{1} - {m}_{2} ) / {ρ}_{L} + {m}_{2} / {ρ}_{P}} \times 100 \qquad ( 1 )$$

wherein, ε represents porosity; m₁ represents a weight of a wet membrane, a unit thereof is g; m₂ represents a weight of a dry membrane, a unit thereof is g; p_{L} represents a density of an infiltrate liquid, a unit thereof is g/cm³; ρ_{P} represents a density of a fluorinated polymer, a unit thereof is g/cm³.

The breaking strength test is provided with a YG061F single-fiber strength tester, samples are porous membrane sample strips, wherein a thickness thereof is 200 μm, a width is 3 mm, and a length is 3 cm. An extension rate is 250 mm/min.

TABLE 4
data list of porosity and breaking strength tests on
porous membranes obtained in preferred embodiments

| | Sample No. | | | | | |
|---|---|---|---|---|---|---|
| | 1# | 2# | 3# | 4# | 5# | 6# |
| porosity (%) | 74.8 | 71.5 | 63.4 | 25.2 | 81.6 | 77.3 |
| breaking strength (MPa) | 1.54 | 4.12 | 8.78 | 11.53 | 1.02 | 1.88 |
| | Sample No. | | | | | |
| | 7# | 8# | 9# | 10# | 11# | 12# |
| porosity (%) | 64.8 | 52.2 | 79.7 | 71.2 | 39.4 | 48.2 |
| breaking strength (MPa) | 3.91 | 4.27 | 1.43 | 5.80 | 9.76 | 6.94 |

One skilled in the art will understand that the embodiment of the present invention as described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A membrane formulation of fluorinated copolymer porous membrane, comprising:
a fluorinated copolymer 15-50 wt %;
a diluent 30-85 wt %; and
a composite pore-forming agent 0-20 wt %; totally 100 wt %;
wherein the fluorinated copolymer is ethylene-chlorotrifluoroethylene copolymer;
wherein the diluent is selected from a group consisting of di-isooctyladinpate, di-isooctyladinpate with dibutyl phthalate, diethyl phthalate and dioctyl phthalate, with any proportion;
wherein the composite pore-forming agent is a dissoluble pore-forming agent or a non-dissoluble pore-forming agent.

2. The membrane formulation of fluorinated copolymer porous membrane, as recited in claim 1, wherein the fluorinated copolymer is the ethylene-chlorotrifluoroethylene copolymer formed by alternating copolymerization of ethylene and chlorotrifluoroethylene monomer with a proportion of 1:1.

3. The membrane formulation of fluorinated copolymer porous membrane, as recited in claim 1, wherein the dissoluble pore-forming agent is water-soluble inorganic particles, a water-soluble polymer, or a mixture of the water-soluble inorganic particles and the water-soluble polymer with any proportion; the non-dissoluble pore-forming agent is non-water-soluble inorganic particles.

4. The membrane formulation of fluorinated copolymer porous membrane, as recited in claim 3, wherein the water-soluble inorganic particles are selected from a group consisting of LiCl, CaCl₂, NaCl and KCl with an average particle size of 0.01-5 μm; the water-soluble polymer has a decomposing temperature higher than a processing temperature of the ethylene-chlorotrifluoroethylene copolymer; the non-water-soluble inorganic particles have an average particle size of 0.01-5 μm, and are SiO₂, CaCO₃, or SiO₂ and CaCO₃ with any proportion.

5. The membrane formulation of fluorinated copolymer porous membrane, as recited in claim 3, wherein the water-soluble polymer is polyoxyethylene or polyethyleneglycol.

6. A method for preparing a fluorinated copolymer flat porous membrane with a fluorinated copolymer porous membrane formulation as recited in claim 1, comprising steps of:
1) evenly mixing a fluorinated copolymer, a diluent and a composite pore-forming agent with a certain proportion, for forming a viscous mixture;
2) pre-heating a mould of a hot-presser with a temperature of 170-200° C., pouring the viscous mixture into the mould after a mould temperature is balanced, pressing with a pressure of 10-30 MPa after the viscous mixture is completely melted and forms a homogeneous phase, so as to form a first flat membrane; and
3) cooling the mould with cool water, taking the first flat membrane out after being cooled and solidified, extracting with alcohol for obtaining a first fluorinated copolymer flat porous membrane.

7. A method for preparing a fluorinated copolymer flat porous membrane with a fluorinated copolymer porous membrane formulation as recited in claim 1, comprising steps of:
1) evenly mixing a fluorinated copolymer, a diluent and a composite pore-forming agent with a certain proportion, for forming a viscous mixture; thoroughly stirring the viscous mixture at 180-200° C., for forming a homogeneous phase solution, then keeping a temperature at 180-200° C. and waiting for deforming, so as to obtain a homogeneous casting solution;
2) rapidly coating the casting solution on a clean glass board which is thoroughly pre-heated at 170-200° C., for obtaining a second flat membrane; and
3) putting the second flat membrane at a 20-80° C. water bath, taking out after being cooled and solidified, extracting with alcohol for obtaining a second fluorinated copolymer flat porous membrane.

8. A method for preparing a fluorinated copolymer hollow fiber porous membrane with a fluorinated copolymer porous membrane formulation as recited in claim 1, comprising steps of:
1) evenly mixing a fluorinated copolymer, a diluent and a composite pore-forming agent with a certain proportion, for forming a viscous mixture;
2) inputting the viscous mixture into a screw extruder, extruding out through a hollow spinning nozzle at 170-200° C., passing through a 20-150 mm air layer, then immersing into a 20-80° C. water bath for being solidified, so as to obtaining a first primary hollow fiber; and
3) extracting the first primary hollow fiber with alcohol for obtaining a first fluorinated copolymer hollow fiber porous membrane.

9. A method for preparing a fluorinated copolymer hollow fiber porous membrane with a fluorinated copolymer porous membrane formulation as recited in claim 1, comprising steps of:
1) evenly mixing a fluorinated copolymer, a diluent and a composite pore-forming agent with a certain proportion, for forming a viscous mixture; thoroughly stirring the viscous mixture at 180-200° C., for forming a homogeneous phase solution, then keeping a temperature at 180-200° C. and waiting for deforming, so as to obtain a homogeneous casting solution;
2) inputting the casting solution into a screw extruder, extruding out through a hollow spinning nozzle at 170-200° C., passing through a 20-150 mm air layer, then immersing into a 20-80° C. water bath for being solidified, so as to obtaining a second primary hollow fiber; and
3) extracting the second primary hollow fiber with alcohol for obtaining a second fluorinated copolymer hollow fiber porous membrane.
